(19) United States
(12) Patent Application Publication
(10) Pub. No.: US 2018/0068367 A1
(43) Pub. Date: Mar. 8, 2018

(54) TELEMATIC SYSTEM AND METHOD FOR CONFIGURING AN ARTICLE

(71) Applicant: ELSE CORP S.r.l., Milano (IT)

(72) Inventors: Andrey Golub, Milano (IT); Taira Colah, Milano (IT); Daria Kosheleva, Milano (IT)

(73) Assignee: ELSE CORP S.r.l., Milano (IT)

(21) Appl. No.: 15/692,825

(22) Filed: Aug. 31, 2017

(30) Foreign Application Priority Data
Sep. 1, 2016 (IT) 102016000088910

(51) Int. Cl. G06Q 30/06; G06F 17/30; G06F 3/0482; G06F 3/0488

(52) U.S. Cl. CPC G06Q 30/0621; G06Q 30/0627; G06F 3/0488; G06F 17/30899; G06F 3/0482; G06Q 30/0643

(57) ABSTRACT

A telematic system for configuring an article may include a displaying device (2) such to take a first displaying mode (PH2) wherein it shows first constructive characteristics of the article and a second displaying mode (PH3) wherein it shows second constructive characteristics of the article, selectable by the user. The system may also include an interface device (1) such to take a first operative mode (PH2) enabling to select the first constructive characteristics and a second operative mode (PH3) enabling to select the second constructive characteristics, a filing and processing system (3) communicating with the devices (1, 2) for commanding them to switch from the respective first modes to the respective second modes upon a selection by the user of at least one characteristic belonging to the first constructive characteristics.

### TECHNICAL FIELD

The present invention refers to telematic systems.

### PRIOR ART

The so-called online shop and online store wherein the means by which a purchase is done is a web site, and wherein the economic transaction occurs completely via Internet, are known. On the contrary, the product can be delivered on-line if the purchased product has an electronic format (for example mp3-format songs, software programs, videogames, applications) or the product is physically shipped.

Moreover, there are sellers of clothes and accessories which can be provided with virtual dressing rooms wherein the customer can load his/her image for trying a dress or an accessory in a very realistic way.

Document U.S. Pat. No. 8,326,704 describes a virtual reality shop wherein an user can see on a computer a three-dimensional representation of the spaces of a shop in order to imitate a real purchase experience.

### SUMMARY

The Applicant has become aware of the need of proposing a telematic system which can offer the user selection possibilities, with reference to an article of interest, which are greater than the ones offered by the prior art system.

According to a first aspect, the invention refers to a telematic system for configuring an article, comprising:

a displaying device configured to assume a first displaying mode wherein it shows first constructive characteristics of the article, selectable by a user, and a second displaying mode wherein it shows second constructive characteristics of the article, selectable by the user:

an interface device configured to assume a first operative mode enabling to select the first constructive characteristics and a second operative mode enabling to select the second constructive characteristics;

a filing and processing system communicating with said devices and structured to command to switch the displaying device and the interface device from the respective first displaying and operative modes to the respective second displaying and operative modes upon a selection by the user of at least one characteristic belonging to the first constructive characteristic.

According to another aspect, the present invention relates a method of telematically configuring an article comprising:

providing a filing and processing system which stores first and second constructive characteristics of an article to be configured by an user;

showing to a user, by a displaying device, the first constructive characteristics according to a first displaying mode;

selecting by the user and by means of an interface device (at least one first characteristic of the first characteristics and supplying a corresponding selection signal to the filing and processing system; the interface device having taken a first operative mode correlated to the first characteristics to be selected;

receiving from the filing and processing system the selection signal, processing such signal and supplying:

first command signals to the displaying device for showing the user second constructive characteristics of the article to be selected;

second command signals to the interface device so that it takes a second operative mode correlated to the second characteristics to be selected.

### BRIEF DESCRIPTION OF THE DRAWINGS

In the following some exemplifying and non-limiting embodiments will be described with reference to the attached drawings, wherein:

FIG. 1 schematically shows an example of a telematic system for configuring articles, comprising a control device, a displaying device, and a filing and processing system;

FIG. 2 shows a particular example of a first table of characteristics selectable by an user, storable in said filing and processing system;

FIG. 3 and FIG. 4 illustratively show what the interface device and displaying device, display during some steps of a telematic method for configuring articles;

FIG. 5 shows a particular example of a second table of characteristics selectable by an user, storable in said filing and processing system;

FIGS. 6A and 6B generally show a particular example of a third table of characteristics selectable by an user, storable in said filing and processing system.

### DETAILED DESCRIPTION

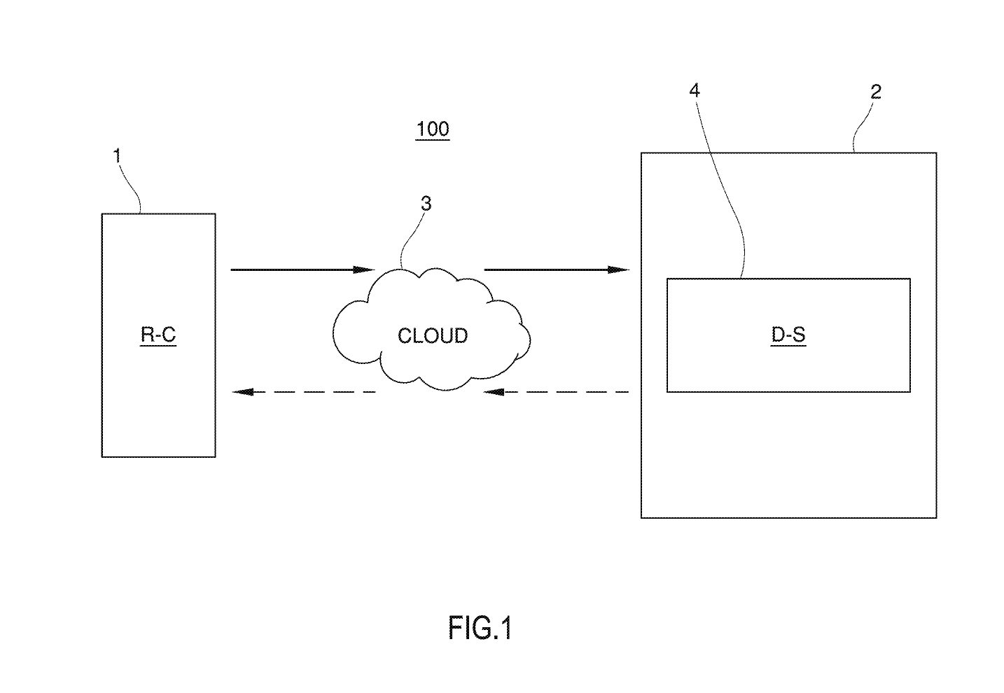

FIG. 1 shows a telematic system for configuring articles 100 comprising a remote control device 1 (R-C), a displaying device 2 and a data filing (i.e. archiving) and processing system 3 (CLOUD).

The remote control device 1 is an electronic device structured for operating as an interface and input device for a final user. Particularly, the remote control device 1 enables an user to output command signals to the data filing and processing system 3.

The remote control device 1 (shortly known as control device) can be, for example, a cellular phone, a portable computer, a tablet or a pair of glasses adapted to the virtual reality.

The control device in order to enable an user to input choices, can be provided, for example, with a physical keyboard or touchscreen or another interface means such as one regarding a vocal mode or one implemented by virtual reality glasses.

Moreover, the control device 1 is structured for exchanging commands and data with the data filing and processing system 3. Such exchange can be performed, for example, by a wireless communication according to a suitable standard such as, for example, the Bluetooth standard or the Wi-Fi technology.

Particularly, the control device 1 is configured for loading graphic interfaces adapted to a particular operative mode.

The displaying device 2 comprises a monitor (or any kind of screen) 4 for displaying two-dimensional and/or three-dimensional objects by suitable graphic interfaces, and is connected to the data filing and processing system 3.

Moreover, the displaying device 2 is structured for exchanging commands and data with the data filing and processing system 3. Such exchange can be performed, for example, in the same way as the one described with reference to the control device 1. The displaying device 2 can be a computer such as a portable computer or a tablet, or an embedded device, for example.

The control device 1 and the displaying device 2 are implemented so that the user is provided with the control device 1 and can see what is displayed on the displaying device 2.

According to a particular example, the displaying device 2 and control device 1 can be integrated in a single apparatus, such as for example virtual reality glasses.

The data filing and processing system 3 is provided with software modules enabling to manage the configuring method, synchronizing some operative steps of the displaying device 2 and control device 1, to acknowledge the command signals received from the displaying device 2 and control device 1, to output data and instructions to the displaying device 2 and control device 1.

The data filing and processing system 3 is provided with storing means which store data and procedures regarding the method for configuring articles.

The data filing and processing system 3 is provided with an apparatus enabling the communication with the control device 1 and displaying device 2, as hereinbefore described.

The data filing and processing system 3 comprises at least one computer which, particularly, can be part of a telematic network. Advantageously, such computer (residing nearby or remote from the control device 1 and displaying device 2) is capable of establishing a connection to Internet. Preferably, the data filing and processing system 3 is part of a cloud capable of operating both as a cloud storage and as cloud computing, for processing and analyzing data, user actions and other analyses and processings before and after a configuration event.

The telematic system 100 for configuring articles is such to enable an user to configure, by software, a determined article through the control device 1 in order to perform determined selections among a variety of options, which are visually provided by the displaying device 2.

The term “configuring an article” means defining a plurality of constructive characteristics (inside a predefined set) enabling to completely design the article itself or parts thereof. For example, these constructive characteristics can be related to the shape of the article, materials, colors, fundamental constituent elements and/or in relation to accessory elements of the article and/or related to merely cosmetic elements. These accessory and/or cosmetic elements can also be independently designed and then proposed for being integrated inside the structure of the article.

The telematic system 100 for configuring articles can be used for configuring articles of different types such as, for example, clothes (for example: clothing, garments, etc.), accessories for clothing (for example: bags, belts, etc.), footwear, jewelry, fake jewelry, watches, accessories for electronic devices, design articles, furniture, products destined to a personal use, automobiles, etc.

The filing and processing system 3 has the function of storing data and procedure rules, of controlling and commanding what is displayed on the displaying device 2 with reference to the characteristics of the article: characteristics which can be selected by an user through the control device 1.

Particularly, the filing and processing system 3 is such to output signals to the displaying device 2, so that this latter loads different graphic interfaces according to the characteristics to be shown to the user for enabling to select the options which are proposed to him/her.

Switching from a display to a following one is performed by the filing and processing system 3 by also considering signals output by the control device 1 to the filing and processing system 3, corresponding to a determined selection of characteristics provided by the user.

It is observed that the control device 1 exhibits an operative configuration of the interface with the user, which can be modified, by the filing and processing system 3, in order to adapt it to the characteristics among which the user can do a selection, also at each step of the process for configuring an article or parts thereof.

It is assumed, for example, that the filing and processing system is a cloud 3. Moreover, in an exemplifying and non-limiting way, in the following it is made reference to a shoe.

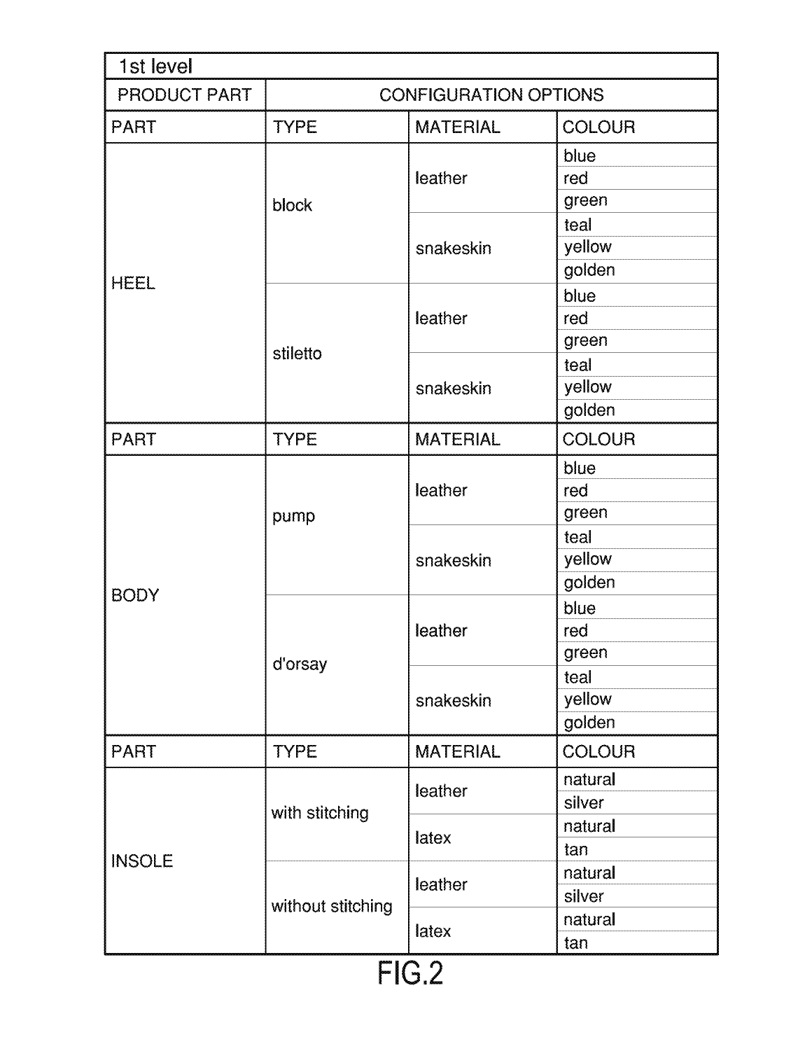

FIG. 2 shows an example of a table (which can be further extended), of some constructive characteristics of a shoe (in other words the article or product), storable in the cloud 3. As it is evident, the table in FIG. 2, shows the “part of product” and some “configuration options”.

The parts of the products are, in the example: heel, body, back portion (back). Inside the “configuration options”, each part of the product, can subdivided in: “type”, “material”, and “color”. According to the example, the heel could be of a “stiletto” type, the material could be “leather” and the color could be “red”.

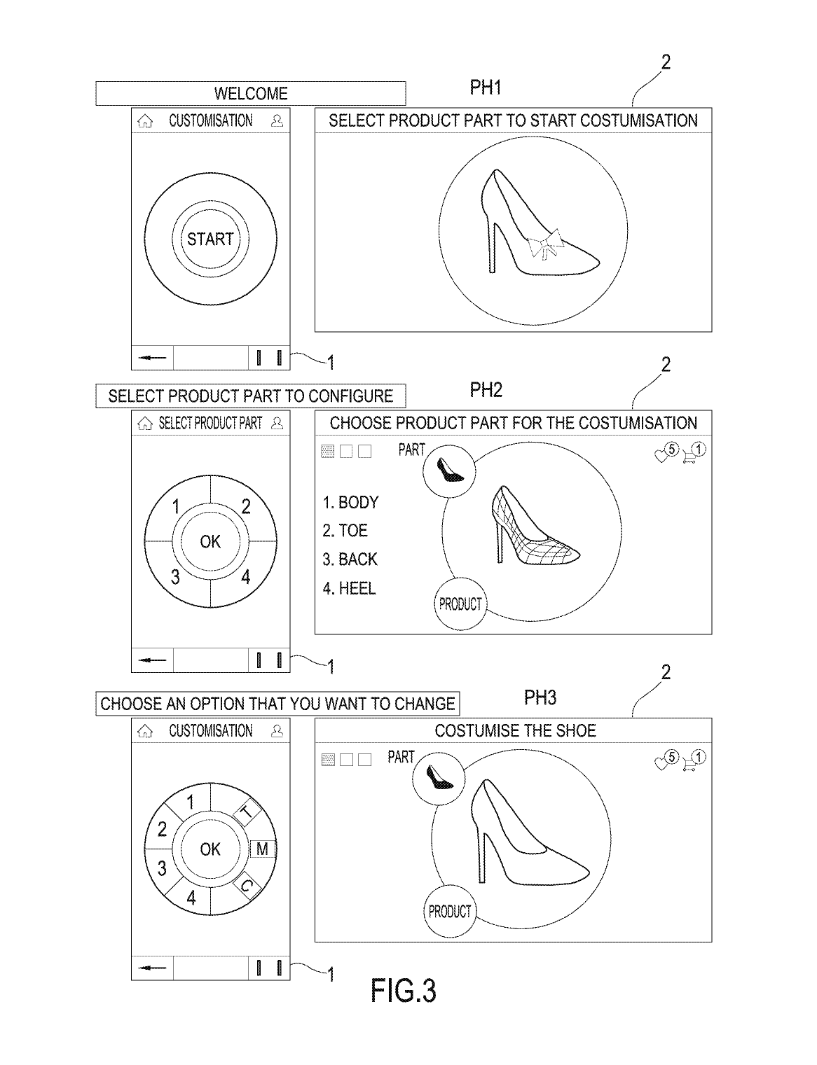

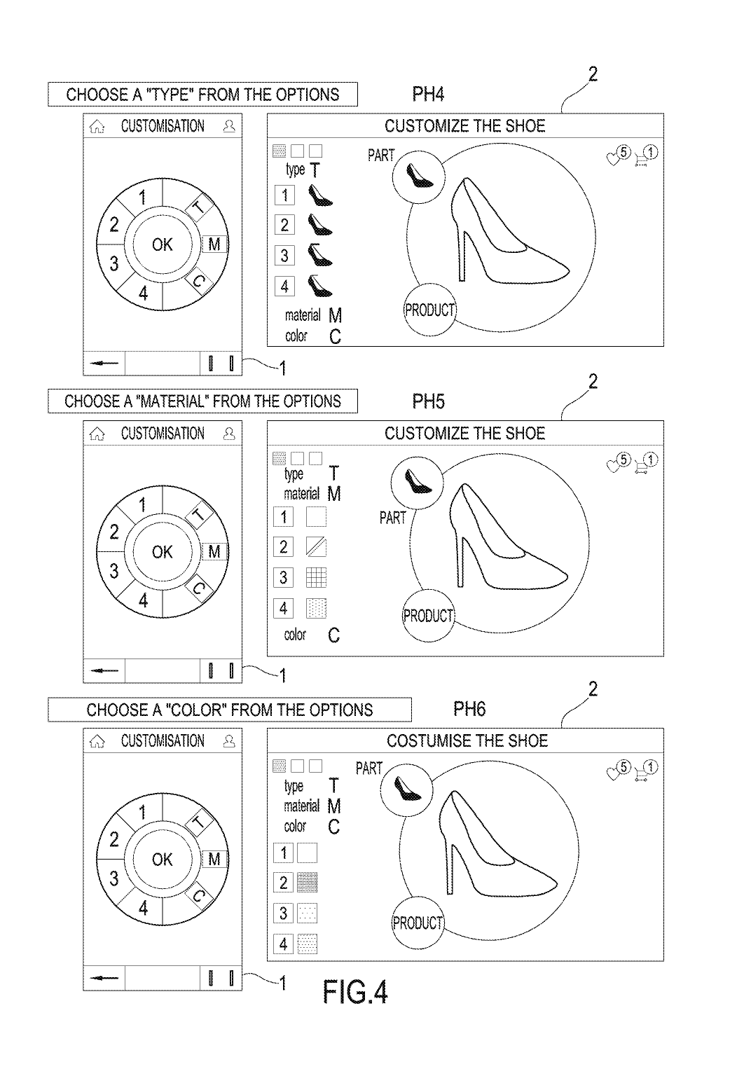

FIG. 3 and FIG. 4 show an example of a mode of displaying the constructive characteristics and a mode by which these are selected by the user.

More particularly, FIGS. 3 and 4 illustrate what the displaying device 2 shows and what is shown by the control device 1, of a touch screen type, during some exemplifying operative steps. As already discussed, suitable graphic interfaces are loaded by the displaying device 2 and control device 1 based on command signals output by the cloud 3.

Referring again to the example in FIGS. 3 and 4, in a first step (the “welcome” step, first step PH1) the displaying device 2 shows an image of a shoe, and the control device 1 enables the possibility of starting the configuring method by showing the word “Start”, selectable or clickable by the user.

After the user has selected “Start”, the control device 1 outputs a respective signal to the cloud 3 in which this signal is acknowledged according to a managing software application stored in it. Therefore, the cloud 3 commands to load a graphic interface different from the previous one into the displaying device 2 and control device 1. The control device 1 and displaying device 2 output respective signals to the cloud 3, in order to indicate they loaded respective graphic interfaces.

As shown in the example in FIG. 3, then there is a step of “Select Product Part To Configure” (second step PH2).

In such second step PH2, the displaying device 2 shows four different options selectable by the user for selecting which part to configure of the shoe:

1. Body

2. Toe

3. Back

4. Heel

As shown in the example of the second step PH2, each option (body, toe, back, heel) is associated to a number: 1, 2, 3, and 4. The control device 1 has loaded a graphic interface by which it shows the possibility of selecting one of the above mentioned four options, in the example, identified by numbers from 1 to 4. In the particular example shown in FIGS. 3 and 4, the control device 1 displays the mode of selecting the choices by a circle sector representation.

When the user has selected a structural part of the product, for example, the “body” which he/she will configure in the following options, the system goes to the third step PH3: Choose An Option That You Want To Change.

The cloud 3 commands the control device 1 so that this latter loads data and a graphic interface, which can be beforehand pre-loaded or during the process in a “predictive” way, which enables the user to select one among the four following options exemplifyingly indicated as: “Type, T”, “Material M” and “Color, C”, which indicate the characteristics on which the user can act by choosing a possible configuration.

In the following fourth step PH4 (Choose A Type From The Options) in FIG. 4, a further graphic interface showing different types of a body by different graphic representations associated to the different options is loaded in the displaying device 2. As in the previous steps, also in the fourth step PH4, the control device 1 enables the user to perform a corresponding selection by loading a corresponding graphic interface.

In a fifth step PH5 (choose a material from the options), different types of materials are shown to the user and the user can perform, analogously to the previous cases, a corresponding selection by the control device 1, of the material for the body.

In a sixth step PH6 (Choose A Color From The Options), different types of colors are shown to the user, and he/she can perform, a corresponding selection of the color for the body analogously to the previous cases.

The methodology, exemplifyingly described with reference to FIGS. 3 and 4, enables the user to configure the characteristics of the article according to the table in FIG. 2. The described steps can be performed also with a sequence different from the one illustratively described, and only some parts of such steps can be performed as a function of the needs of the user for generating a configuration, or based on limitations set by the selling or marketing process of the business selling the article.

As it is observed from the shown examples, as the selections performed by the user advance, the cloud 3 can also command the displaying device 2 to show graphic representations of the article which is gradually configuring.

Advantageously, the configuring system 100 enables the user to return to already configured characteristics in order to modify them during any steps of the configuring method.

It is noted that the example described with reference to FIGS. 3 and 4, refers to the configuration of those characteristics which could be defined (according to an exemplifying classification) both as “structural” characteristics and as corresponding base elements of the shoe, in this example.

As it follows also from the above described example, the selection of the characteristics follows, for example, this outline: selection of the “type”, selection of the “material”, selection of the “color”, which are not necessarily all made and specified by the user. Moreover, according to this setting, after selecting the part to be configured, the corresponding configuration thereof is started.

Advantageously, the configuring method can comprise, besides the above described first configuring level, regarding the structural parts, also a second level regarding further options regarding non-structural but still optional elements of the article to be configured. These further options can refer to accessories or other Extras, the branding or the ID costumer, for example,

According to this example, the Extras are accessory elements of the article which, with reference to the shoe, can be additional cosmetic elements to be applied to the shoe.

The branding refers to the possibility of showing the trademark or logo for detecting the brand of an article, or of loading a logo/custom branding, if allowed and compatible with the logic of the sale and manufacturing.

The customer ID refers to the possibility of inserting a text identifying the user himself/herself, or another user (in case of a gift or similar), or a free text, a date to be stored or other customizing choices.

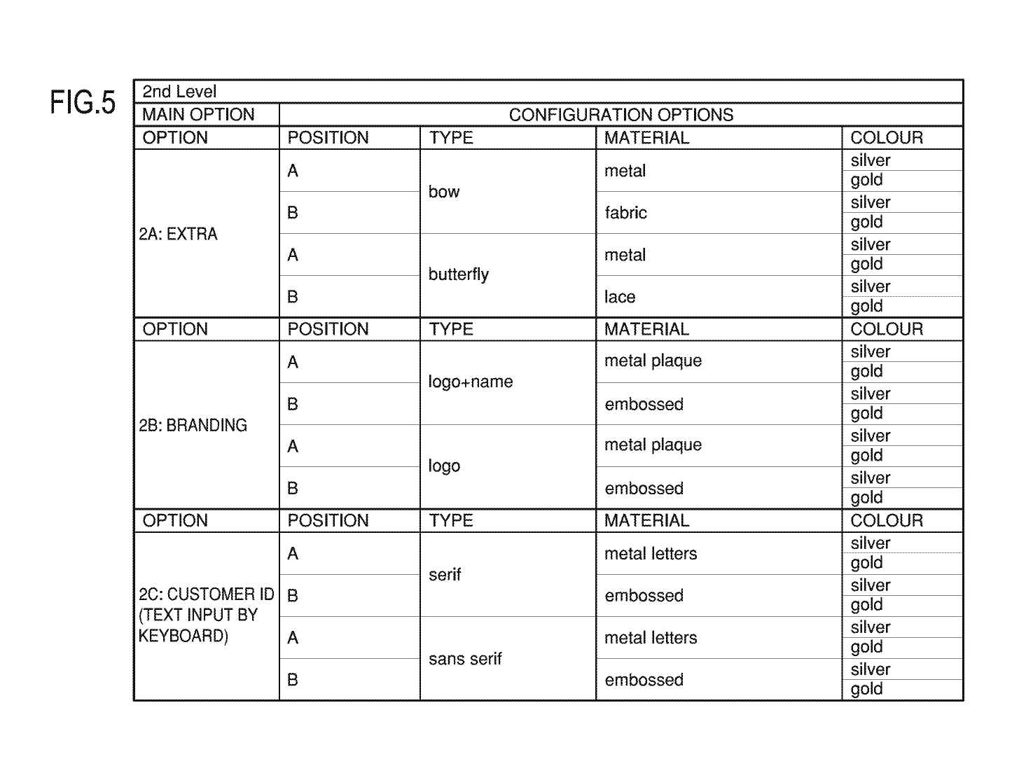

FIG. 5 shows an example of a table containing constructing characteristics of a “second level” of a shoe (in other words the article or product) storable in the cloud 3. The table in FIG. 5 shows the “part of the product” and some “configuration options”. This step is not required for each product and each configuration, but is an extension of the process hereinbefore described.

During the operation, after the first level configuration, there is the second level configuration and it is possible to select, for example with reference to FIG. 5, an accessory Extra, Therefore, the position thereof on the shoe will be selected and then the type (a bow or a butterfly, for example) will be selected, and the material and color will be selected. The mode by which the selections are made in the second level area are the same or analogous to the ones described for the first level, with reference to FIGS. 3 and 4. Also in this case, the displaying device 2 shows the different options offered to the user which he/she can select by acting on the control device 1.

According to a further embodiment, it is also possible to provide a third level of configuration, by which, for example, the user customizes the article in order to configure it as a unique product, or in order to add a portion of the “custom made” product which, although does not belong to the standard configuration set, can be added by the user, obviously the structure and other features thereof must be compatible with the original product.

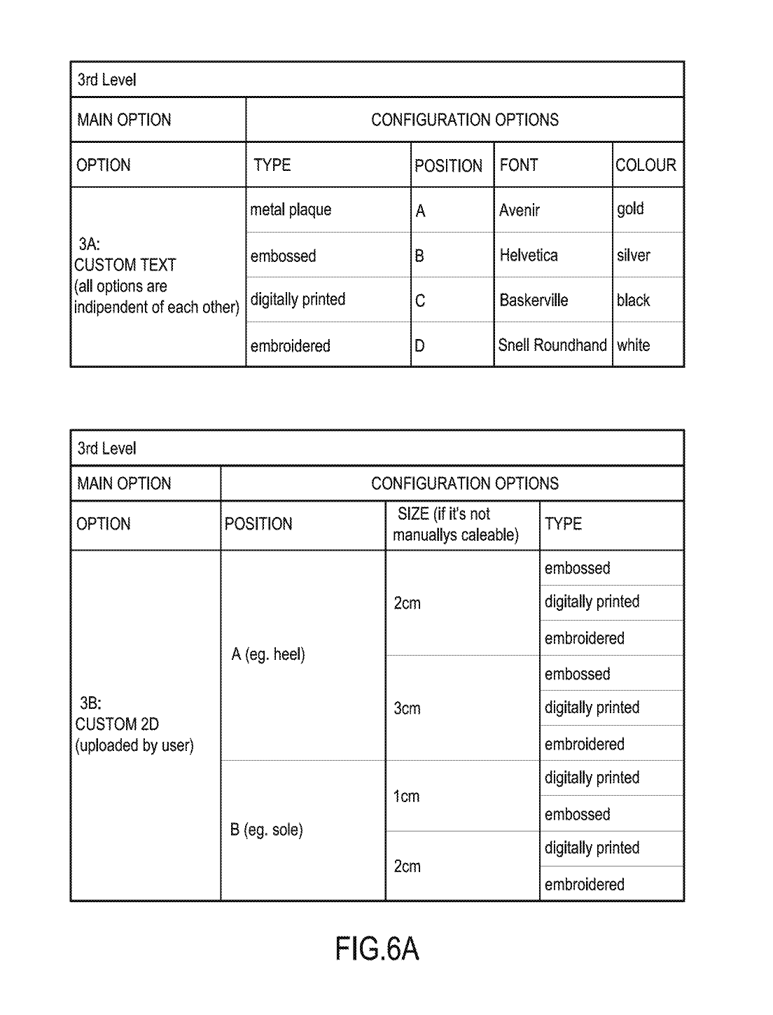

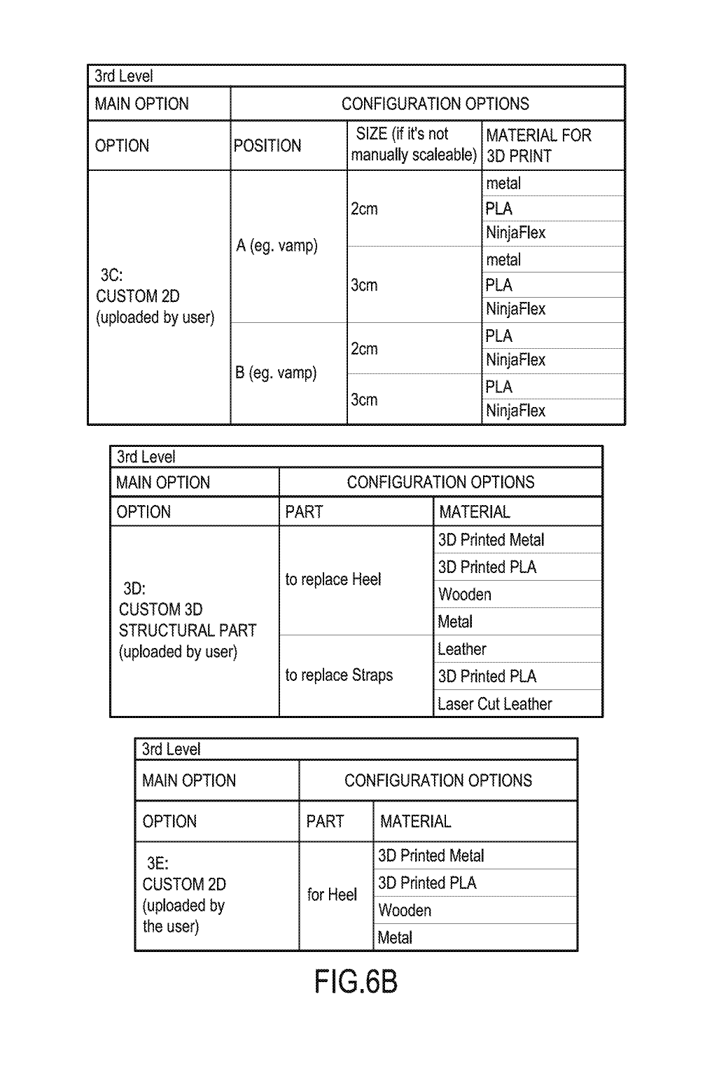

FIGS. 6A-6B generally show an example of a table of “third level” characteristics of a shoe, storable in the cloud 3. The table in FIG. 6 shows five “options” among which a selection can be done:

3A. Configuring a written text;

3B. Configuring a two-dimensional image;

3C. Configuring a three-dimensional accessory element;

3D. Configuring a structural three-dimensional portion;

3E. Configuring a three-dimensional extension: in other words, the possibility of configuring a portion of the product, designed outside, which then is 30 printed and assembled with the original parts; for example, an accessory designed by another designer or by the user himself/herself.

After the user has selected one of such options among 3A, 3B, 3C, and 3E, he/she can perform other selections in order to customize the configuration. In the following, some third-level customizations are illustratively and in a non-limiting way described.

If the user selects the option 3A, he/she can then select the type of accessory to be added on which add a text (for example a metal plate, an embossing, etc.), the position thereof, the font of the text, the color. If the user selects the choice 3B, he/she can then select the position on which the 2D image will be placed on the shoe, the size thereof, the type of the text.

If the user selects the choice 30, he/she can select an accessory on which a text\ will be directly placed.

If the user selects the choice 3D, he/she can replace a structural portion of the shoe, with a portion obtained also by a manufacturing process different from the original one, such as by 3D printing and additive manufacturing, or in a conventional way, as the original portions of the product are manufactured.

The choice 3E is analogous to the 3D one, however it does not refer to a “structural part of the shoe” but to a “optional part”.

With reference to the different selecting steps which can be performed by the telematic system 100 for configuring articles, among the third level options, the cloud 3, displaying device 2 and control device 1 can operate analogously to what has been already described with reference to the third level.

It is observed that a software resides in the filing and processing system 3, which enables to an administrator (or to a process which synchronizes the configuring data with other data of the product, for example: by software such as PLM, PDM) to introduce filtering laws limiting the possible choices for the user, with reference to an outline of a complete configuration.

According to a particular embodiment, there are possible “style” laws which establish, for example, the selectable colors or other characteristics of the article to be configured.

Moreover, a “combination” rule can be provided which limits the type of the combination of two or more characteristics, selectable by the user. For example, this law can be of a type so that if a determined color is selected for the body (first level), consequently the colors of an accessory Extra or of another structural portion of the shoe, selected and configured in the second level, are restricted.

All the choices selected by the user, are stored in the filing and processing system 3 so that the configuration of each characteristic, performed by the user, is suitably stored.

When the article configuration ends according to the needs of the user, the user can or cannot purchase the configured article, or can save it in the cart, in a “wish list” or in another way, for this purpose or for a following purchase confirmation. Then, the article, configured in this way, if confirmed by the user can, be manufactured on order and shipped to the user if a specific product is not available in the merchant store, or, if the product is already available, can be identified in the local or central store.

As it is evident from the previous description, the described telematic system 100 enables to perform an interactive configuration of an article. The telematic system 100 offers an user the possibility of performing a virtual configuration, in order to obtain an actual customization, of the article of interest. Advantageously, the mode by which the different options are shown to the user enables this latter to easily configure the article although he/she does not have designing skills.

From the point of view of a selling business, the described system and method enable to configure the selling process by a purely “made-to-order” mode and without a store, or by a mixed mode between the “made-to-order” mode and the store which can be small. The “on-request” or “on-order” approach exhibits all the advantages which the “made-to-order” model gives to the retail and marketing process.

1. A telematic system for configuring an article (100), comprising:
a displaying device (2) configured to assume a first displaying mode (PH2) wherein it shows first constructive characteristics of the article, selectable by a user, and a second displaying mode (PH3) wherein it shows second constructive characteristics of the article, selectable by the user;
an interface device (1) configured to assume a first operative mode (PH2) enabling to select the first constructive characteristics and a second operative mode (PH3) enabling to select the second constructive characteristics;
a filing and processing system (3) communicating with said devices (1, 2) and structured to command to switch the displaying device (2) and the interface device (1) from the respective first displaying and operative modes to the respective second displaying and operative modes upon a selection by the user of at least one characteristic belonging to the first constructive characteristic.

2. The telematic system (100) according to claim 1, wherein:
the displaying device (2) is such to load a first graphic interface when it takes the first displaying mode (PH2) and a second different graphic interface when it takes the second displaying mode (PH3).

3. The telematic system (100) according to claim 2, wherein the filing and processing system (3) is structured to:
storing at least one characteristic between said first characteristics and second characteristics selected by the user;
synchronizing the switching of the displaying device (2) between the first and second displaying modes with the switching of the interface device (1) from the first operative mode to the second operative mode.

4. The telematic system (100) according to claim 2, wherein the interface device (1) is such to load a respective first graphic interface when it takes the first operative mode (PH2) and a respective second graphic interface when it takes the second operative mode (PH3).

5. The telematic system (100) according to claim 4, wherein the interface device (1) is such to show to the user a plurality of options, each selectable by the user and each being associated to a corresponding characteristic of said first characteristics.

6. The telematic system (100) according to claim 5, wherein:
the interface device (1) comprises at least one of the following devices: touchscreen, virtual reality glasses; a control device remote from the displaying device;
the displaying device (2) comprises a screen for displaying images and graphic representations;
the filing and processing system (3) comprises at least one of the following apparatuses: a computer, telematic network, cloud storage and cloud computing, internet browsing system.

7. The telematic system (100) according to claim 1, wherein said first and second constructive characteristics of the article, selectable by the user, comprise at least one of the following characteristics: identification of structural parts; shape, constituent materials, colours of said structural parts.

8. The telematic system (100) according to claim 1, wherein said first and second constructive characteristics of the article selectable by the user, comprise at least one of the following characteristics: identification of accessory objects of the article; shape, constituent materials, colours of said accessory objects.

9. The telematic system (100) according to claim 1, wherein in the filing and processing system (3), resides:
a software module managing style rules, configured for selecting and defining said first characteristics to be proposed to the user;
a software module managing combination rules, configured for defining association rules between the first and second characteristics by defining preferred associations and excluded associations.

10. A method of telematically configuring an article comprising:
providing a filing and processing system (3) which stores first and second constructive characteristics of an article to be configured by an user;
showing to a user, by a displaying device (2), the first constructive characteristics according to a first displaying mode;
selecting by the user and by means of an interface device (1) at least one first characteristic of the first characteristics and supplying a corresponding selection signal to the filing and processing system (3); the interface device (1) having taken a first operative mode correlated to the first characteristics to be selected;
receiving from the filing and processing system (3) the selection signal, processing such signal and supplying:
first command signals to the displaying device (2) for showing the user second constructive characteristics of the article to be selected;
second command signals to the interface device (1) so that it takes a second operative mode correlated to the second characteristics to be selected.
